(19) United States
(12) Patent Application Publication
(10) Pub. No.: US 2008/0172783 A1
(43) Pub. Date: Jul. 24, 2008

(54) Bathtub with air-water injection system

(76) Inventors: Scott A. Smith, Lago Vista, TX (US); James Riewe, Liberty Hill, TX (US); Michael Faulstich, Cedar Park, TX (US)

Correspondence Address: LASCO BATHWARE, INC., C/O THE GATES CORPORATION IP LAW DEPT. 10-A3, 1551 WEWATTA STREET, DENVER, CO, 80202, US

(21) Appl. No.: 11/655,574

(22) Filed: Jan. 19, 2007

(51) Int. Cl. A61H 33/02

(52) U.S. Cl. 4/541.4

(57) ABSTRACT

A bathtub having a water pump and heater for heating and circulating water from the bathtub to at least one mixing chamber, an air blower and heater for delivering heated ambient air to the mixing chamber, and a plurality of orifices for delivering an air-water mixture from the mixing chamber to the bathtub. A wall of the mixing space may be associated with a wall of the bathtub, and the orifices may be in the wall providing direct fluid communication between the mixing space and the tub. The invention provides improved thermal stability and eliminates evaporative cooling effects in air-injected tubs.

### BACKGROUND OF THE INVENTION

This invention relates generally to a whirlpool bathtub, more particularly to a bathtub having an improved system for mixing and injecting preheated air and water, and specifically to a bathtub having a mixing chamber which supplies heated, equilibrated, air-water mixture to a plurality of orifices in the tub.

It is known how to inject air into a bathtub through a plurality of orifices in the side walls or bottom of the tub connected to an air supply system. It is known to preheat the air before injection into a tub. The air bubbles in the bathtub provide a gentle massaging effect to a bather. Representative of the art is U.S. Pat. No. 6,317,903. A problem with air-injected bathtubs is that air exhibits an evaporative cooling effect on the tub water and on the skin of an occupant. Even heated air feels cool on an occupant's skin upon injection into the tub water.

It is known to provide a water circulating pump to draw water from the tub and pump it to one or more nozzles which inject the water back into the tub. The water nozzles or jets provide a much more vigorous massaging effect than the above-mentioned air bubbles. Water jets can be heated to help maintain the tub water temperature. The gentle effect of bubbles is preferred by many tub users.

It is known to provide Venturi-effect nozzles which inject a water-air mixture into a whirlpool tub. Representative of the art are U.S. Pat. Nos. 3,890,656 and 5,095,558. Venturi nozzles are limited in that the maximum air-to-water ratio that can be achieved is relatively low, so the gentle massaging effect of bubbles is dominated by the stronger effect of the water jet. The nozzles draw in the air by creating a low pressure region in the water stream at or just downstream of a contraction. The mixture is immediately discharged from the nozzle into the tub. Thus, the air feels cool because of the short residence time for air and water mixing, the lack of air heating, and evaporative cooling effects. It is known to provide a forced air supply to a venturi to increase the air-to-water ratio, however, this does not improve the short mixing residence time in the venturi or the evaporative cooling effect. Representative of the art is U.S. Pat. No. 4,419,775.

It is known to provide a whirlpool bath or pool with dual injection systems: a plurality of water jets or water-air venturi jets supplied by a water circulation system and a plurality of air jets supplied by an air pump system. An example is U.S. Pat. No. 5,898,958. Each of the two systems retains the limitations discussed above. It is not known to provide a mixing chamber in which preheated water and air can be efficiently mixed before injection into the tub through a plurality of orifices.

### BRIEF SUMMARY OF THE INVENTION

The present invention provides a bathtub with an improved air-water injection system which includes mixing heated air and water before injection into a bathtub, and which provides for better thermal equilibrium and/or vapor-liquid equilibrium of the mixture and a broader range of air-to-water ratio than possible with a venturi system. This prevents an evaporative cooling affect on skin.

The present invention is directed to a bathtub with a water pump for circulating water from the bathtub to at least one enclosed space or mixing chamber, a water heater for heating the circulating water, and an air blower and heater for delivering heated ambient air to the mixing chamber. The mixing chamber has or is in communication with a plurality of orifices through which an air-water mixture is delivered into the bathtub. The mixing chamber may have one or more each of water inlets and air inlets.

An aspect of the invention is that the orifices may provide fluid communication between the mixing chamber and the bathtub either directly or via a manifold/piping system.

Another aspect of the invention that the air-water ratio may be in the range of from about 50% to about 99% by volume, or from about 70% to about 99% by volume, or from about 90% to about 99% by volume.

Another aspect of the invention that the air-water mixture may have a residence time in the mixing chamber of at least about one-third second, or at least one-half second, or at least about one second.

In other aspects, the mixing chamber may be in the form of a half pipe covering the orifices or following an orifice pattern. The mixing chamber air inlet may be a plurality of air inlet orifices in the half pipe.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is an exploded bottom perspective view of an embodiment of the invention;

FIG. 2 is a partial cutaway top perspective view of the embodiment of FIG. 1;

FIG. 3 is a schematic view of an embodiment of the invention;

FIG. 4 is a partial cutaway perspective view of an embodiment of the invention;

FIG. 5 is a bottom perspective view of an embodiment of the invention;

FIG. 6 is a bottom perspective view of an embodiment of the invention; and

FIG. 7 is a perspective side view of an embodiment of the invention.

### DETAILED DESCRIPTION OF THE INVENTION

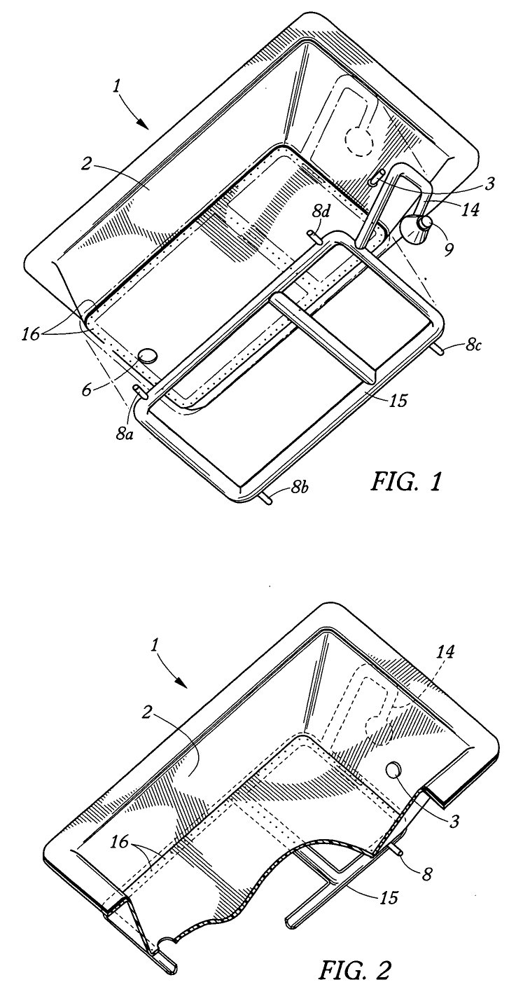

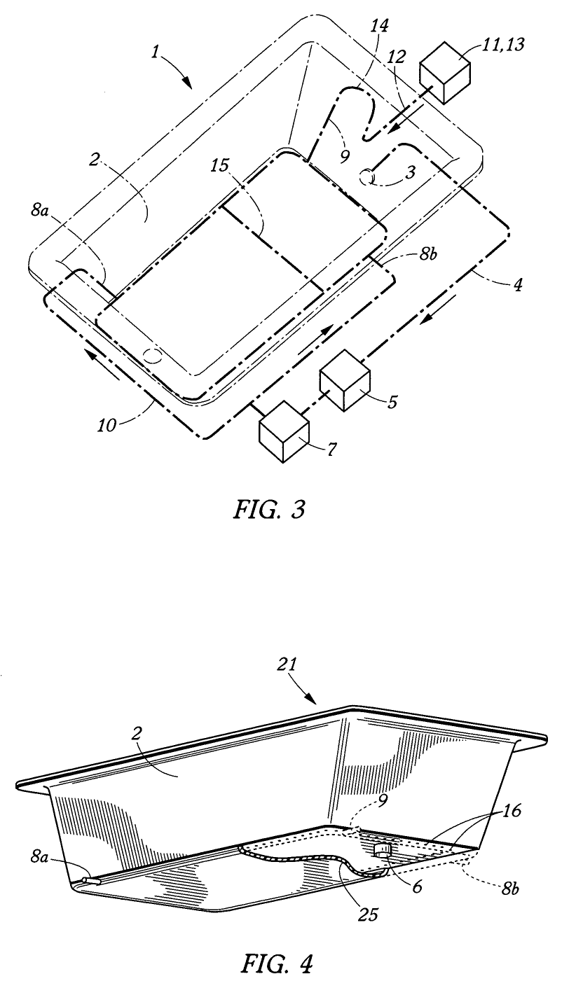

FIG. 1-3 show whirlpool bathtub 1 according to a first embodiment of the invention. Tub 2, shown with generally rectangular shape, may have side walls and bottom wall of any shape and size suitable for holding water and a bather, including various optional features not shown such as seat, arm rest, head rest, and the like. The tub may be provided with drain hole 6. The tub is provided with a water circulation system, illustrated primarily in FIG. 3, comprising suction opening 3, suction tube 4, water pump 5, water heater 7, water supply tube 10, and mixing chamber 15. The water circulation system may include a check valve or valves, connecting tubing, fittings and the like as needed. The tub is also provided with an air supply system comprising air blower 11, air heater 13, and air supply tube 12, along with any additional fittings, valves, check valves, and the like as needed. The air blower and heater may be an integral unit as indicated in FIG. 3. Mixing chamber 15 has at least one water inlet opening 8 connected to water supply tube 10 and air inlet opening 9 connected to air supply tube 12. Air supply tube 12 may include Hartford loop 14 either upstream or downstream of air inlet 9. In the embodiments shown in FIG. 1-4, mixing chamber 15 is an enclosed space having a top wall associated with the bottom wall of the tub. The associated wall has a plurality of orifices 16 providing communication between the chamber and the tub.

The bathtub may optionally be provided with more than one mixing chamber 15. Each additional chamber has separate air and water inlets, is associated with a different wall or section of wall of the tub, and has a plurality of orifices through the associated wall. Thus, each of such multiple chambers would supply a separate plurality or group of orifices with an air-water mixture.

The mixing chamber or chambers may optionally be provided with more than one water inlet as illustrated by water inlets 8a and 8b in FIG. 3 or as illustrated by water inlets 8a, 8b, 8c, and 8d in FIG. 1.

In operation, water pump 5 draws water from tub 2 through suction opening 3 and into suction tube 4. Pump 5 then forces the water through water heater 7 and into mixing chamber 15 via connecting water tube 10 and through water inlet opening or openings 8 into mixing chamber 15. Likewise, ambient air is drawn into blower 11 and heater 13 and forced into mixing chamber 15 through air inlet opening 9 via air supply tube 12. The air and water are subjected to turbulent mixing in mixing chamber 15. The mixing action is driven by the energy imparted to the air and water by the air blower and water pump respectively. The air-water mixture is then forced through apertures or orifices 16 in the bottom of the tub. The air-water mixture is thus injected into whirlpool bathtub 1.

FIGS. 1-2 illustrate an embodiment of the invention wherein mixing chamber 15 is in the form of a half-pipe arranged to coincide with a hole pattern in the tub bottom and cover the orifices 16 making up the hole pattern. Air inlet 9 to the mixing chamber is adapted to attach to the piping from the air blower/heater (not shown). The heated air flows from the inlet into Hartford loop 14, and then into mixing chamber 15. Water inlets 8a-d or 8 to the mixing chamber are illustrated in FIGS. 1 and 2 respectively, although any suitable number of water and/or air inlets may be provided.

The water inlets are adapted to attach to the piping from water heater 7 and pump 5 (shown in FIG. 3). The tub has water outlet fitting 3 adapted to direct water from the tub into the water pump circuit. Water and air pipes, pumps and heating features and associated controls are not shown, but may be provided as illustrated in FIG. 3 and discussed previously. Thus, heated water and air in a desired proportion are provided to the mixing chamber where they admix and reach, or at least approach, a state of thermal equilibrium and vapor-liquid equilibrium. The air-water mixture then is injected directly from the mixing chamber into the bathtub through the plurality of orifices in the bottom wall of the tub. By providing sufficient residence time for thermal and vapor equilibrium between water and air to be reached, the evaporative cooling effect is eliminated and the air-water mixture injected into the bathtub feels warm or hot to the occupant.

A second embodiment of inventive bathtub 21 is shown in FIG. 4, wherein mixing chamber 25 is a single large chamber shaped like a pan covering the entire bottom of the tub 2, but with provision for passage of suitable drain plumbing from drain 6. Mixing of air and water in the mixing chamber may be facilitated by choice of placement and number of air inlet 9 and water inlets 8a and 8b. A suitable arrangement may be to place the air and water inlet openings on separate walls, or in a common pipe depending on tub design, so that the respective flows impinge on each other and mix within the chamber. Mixing chamber 25 shown in FIG. 4 suggests an impingement angle of about 90 degrees between each of two water inlets 8a and 8b and air inlet 9, and an impingement angle of about 180 degrees between the two water inlets. This combination of two water inlets and one air inlet has been found to provide sufficient mixing of the air and water, minimizing the formation of any detrimental dead spots. In an embodiment of the invention, it is advantageous to provide more than one smaller water inlets and one larger air inlet to achieve efficient mixing of air and water.

It should be understood that air and water inlet locations can be altered and optimized on different tub designs. The most important factor in locating the air and water inlets is to avoid placing a water inlet directly in line with an air inlet, thus avoiding the risk of forcing water into the air heating and blowing equipment. Locating the air inlet at least about one foot away from a water inlet also helps keep water out of the blower. A Hartford loop in the air supply tube can also be used to prevent water from entering the blower. Likewise, orifices can be arranged in any pattern desired. For example, orifice size, shape, and location can be optimized around anticipated tub occupant position or ergonomics. Orifices may be drilled at any desirable angle with respect to the tub wall. Orifice openings can be designed to induce a pressure build up and/or to increase residence time within the mixing chamber to ensure adequate thermal equilibrium between air and water is reached.

The mixing chamber is designed to provide sufficient residence time for the air-water mixture to reach, or at least approach, thermal and vapor-liquid equilibrium before injection into the tub. The volume of the chamber divided by the combined volumetric flow rate of the air and water mixture indicates approximately the residence time. A residence time of at least about a third of a second, or at least two-thirds of a second, or at least a second, is believed to be adequate. The various tube diameters, orifice diameters, and pump and blower capacities can be sized by one skilled in the art to provide the desired whirlpool or massaging effects in the tub. A wide variation of designs is available to one skilled in the art to provide for the desired degree of mixing, thermal equilibrium, air-water ratio, and flow rate into the tub. Various tube materials, connector styles, fittings, and the like may be used as needed. Additional check valves, shut off valves, and the like may be incorporated as needed. It may also be advantageous to supply various controls in conjunction with the pump, blower, heaters, and circulation systems for adjusting and maintaining suitable air and water flow rates, pressures, and temperatures and for the safety and comfort of the bather. The air-water injection system may also be used in connection with other whirlpool tub features such as ozonators, filters, and the like. The bathtub may be fitted with other features such as aroma therapy, chromo-therapy, and the like.

The invention is not limited to application in traditional human whirlpool bathtubs. The improved system for injecting an air-water mixture into a vessel of water may be utilized in smaller therapeutic baths, such as foot baths. Alternately, the invention could be utilized in larger baths such as therapeutic whirlpool baths for horses. The air-water injection system of this invention could also be used to provide aeration and circulation for aquariums, ponds, and the like, wherever evaporative cooling from injected air in a body of water is a problem. Thus, it should be understood that the term “bathtub” as used throughout this specification and in the claims may include all kinds of vessels useful for bathing, immersing, and/or soaking, articles, parts, and/or living things in water with injected air-water agitation.

In the design and/or construction of a bathtub, the mixing chamber for injecting an air-water mixture into the bottom of the tub is conveniently formed as a unitary part of the tub, out of the same materials as the rest of the tub. Alternately, the tub and the mixing chamber may be formed separately and then attached in a separate fabrication step. Attachment means is not limited but may be by fasteners of various types, bonding agents, or the like. If the orifice pattern is a single row of holes, it may be convenient to use for the mixing chamber a half-pipe attached to the tub wall directly over the holes. If the orifice pattern is multiple rows, then multiple half-pipe mixing chambers may be mounted over the orifices and connected to one or more water and/or air inlets. Alternately, the mixing chamber may be a whole pipe mounted on the bottom, edge or side or the tub with orifice holes drilled into the pipe through the tub wall. Other mixing chamber arrangements may be within the scope of the invention as further embodiments illustrate.

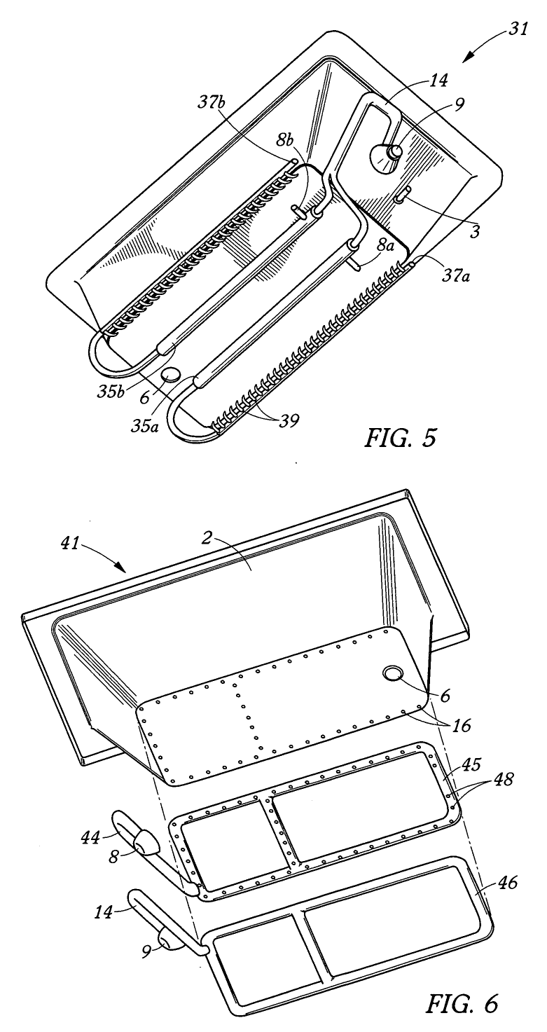

FIG. 5 shows yet another embodiment of a bathtub 31 of the invention, wherein mixing chamber or chambers 35a and 35b may be separate from and not in direct communication with the bath tub. The separate mixing chambers may be connected to manifolds 37a and 37b which distribute the air-water mixture through a plurality of tubes 39 to the plurality of orifices in the tub. It may be desired to provide check valves at each orifice or in each tube 39, for example to prevent backflow from the tub into the supply. Orifice check valves may be heat and/or pressure activated, depending on the desired effects. A series of low pressure check valves at each orifice can prevent unwanted back flow and/or delay injection into the tub until a desired pressure or temperature is reached in the mixing chamber. A manifold system downstream of a mixing chamber is one possible arrangement for supplying air-water mixture to the check valves at each orifice. A manifold system may be attached using fittings, bonding agents, general hardware, and/or the like.

FIG. 6 shows another embodiment of a tub 41 of the invention. As in previous embodiments, tub 2 has orifices 16 in the bottom, and mixing chamber 45 is in the form of a half pipe which covers the orifice pattern. Water is fed to mixing chamber 45 through water inlet 8 and Hartford loop 44. Air is fed to air chamber 46 by means of air inlet 9 and Hartford loop 14. Air is supplied to mixing chamber 45 by means of a plurality of air supply orifices 48 which provide fluid communication between air chamber 46 and mixing chamber 45. Air chamber 46 is also in the form of a half pipe covering mixing chamber 45. In mixing chamber 45 air and water mix before being injected into tub 2 through orifices 16. The number of orifices 16 may be, but need not be, the same as the number of air supply orifices 48. The two sets of orifices may be staggered or offset to maximize the flow path of the air in the mixing chamber.

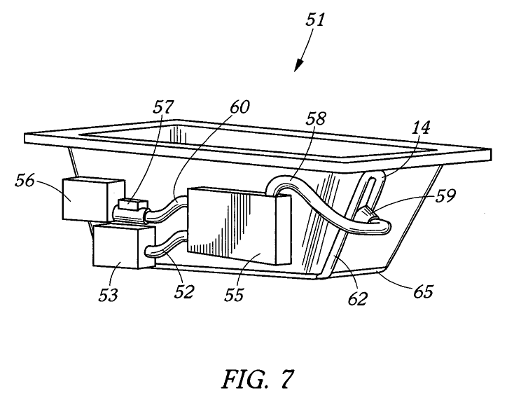

FIG. 7 shows embodiment 51 of the invention having externally mounted mixing chamber 55. Mixing chamber 55 receives water from pump 56 through heater 57 and water inlet 60. Mixing chamber 55 receives air from blower/heater 53 through air inlet 52. The resulting air-water mixture flows out of mixing chamber 55 through outlet 58 to orifice chamber 65 by way of connection 59, Hartford loop 14, and on to orifice chamber inlet 62. Orifice chamber 65 covers an orifice pattern in the tub and supplies the air-water mixture to the tub through the orifices. Orifice chamber 65 may cover the whole tub bottom like mixing chamber 25 in FIG. 4, or it may cover the whole pattern only like mixing chamber 15 in FIG. 2. Alternately, orifice chamber 65 may be replaced by at least one manifold with connections to each orifice as in the embodiment of FIG. 5. An externally mounted mixing chamber may be located on the side, bottom, or the end of the tub or detached from the tub, for example, on a floor or wall of the bath room in which the tub is installed. The mixing chamber may be advantageously located at a level at or below the minimum tub water level or working depth. The bathtubs must generally have a minimum water level several inches above the highest orifice location to prevent water from spraying out the orifices and possibly out of the tub or into the room. More than one mixing chamber may be provided.

### EXAMPLES

A first example tub was constructed according to the embodiment of the invention of FIG. 4. A single mixing chamber was provided having a horizontal area roughly the size and shape of the bottom of the tub and having a height of about two inches (5 cm). The mixing chamber was integrally mounted on the bottom of the tub so that the bottom wall of the tub also served as the top wall of the mixing chamber. Approximately sixty ⅛-inch diameter holes were drilled around the perimeter of the bottom of the tub, providing fluid communication between the mixing chamber and the tub. Two water inlets were provided at opposite ends of the mixing chamber, and an air inlet was provided at one side. Plastic tubing of ½-inch inside diameter (“ID”) was used for the water supply tubes, and plastic tubing of 1-inch ID was used for the air supply line. The water suction line was 1½-inch ID. A centrifugal water pump rated for 0-130 gallons per hour (“gph”) and an in-line water heater rated to heat water to 102-104 degrees Fahrenheit completed the water circulation system. An air blower/heater having a heat rating of 600 watts and capable of from about 12 to about 41 cubic feet per minute (“cfm”) provided the air supply. An electronic control system comprising a computerized control box housing an integrated circuit linked to a keypad was provided for operation of the circulation system.

The first example inventive tub was filled with warm bath water. The air supply blower and water circulation pump were turned on after the tub was filled to an appropriate testing level of at least several inches above the orifices. The air and water immediately began mixing in the mixing chamber and aerated water began entering the tub through the orifices in the bottom wall of the tub. The aerated water was injected at a very uniform temperature, and no evaporative cooling effect was felt in the tub. The massaging action was very pleasant.

A second example tub was constructed according to the embodiment illustrated in FIG. 1-3. The tub had about 60 orifices arranged around the perimeter area of the tub bottom and in a row across the center of the tub bottom. The mixing chamber was constructed by first making an open half-pipe shape (see FIG. 1) and then attaching the half-pipe underneath the tub over the hole locations so that the half-pipe and the tub bottom form the enclosed mixing chamber with the orifices providing direct communication between the chamber and the tub as illustrated in FIG. 2. The half pipe included a Hartford loop and air inlet fixture which were attached to one end of the tub (as shown in FIG. 1-2). The water circulation system described above and illustrated in FIG. 3 was attached to two water inlets and the water flow rate at each inlet was approximately 1.5 to 2 gallons per minute (“gpm”) and constant. The in-line water heater was set to turn on when the water temperature dropped below 98° F. (37° C.). The air circulation system was attached to the air inlet. The variable-speed air blower introduced air to the mixing chamber at a temperature of about 100° F. (38° C.) and at a flow rate adjustable in the range of from 12 to 40 cfm. Thus, the air-water ratio was adjustable from an air volume percent of about 95% to about 99%. In a second experiment, four water inlets of about 2 gpm each were attached to the mixing chamber instead of two, providing a range of air volume percent from about 92% to about 97%. In both cases, upon filling of the tub and operation of the mixing chamber, the air-water mixture was injected at a very uniform equilibrium temperature, and no evaporative cooling effect was felt in the tub. The massaging action was very pleasant.

A third example was constructed according to the embodiment illustrated in FIG. 6. Air was supplied to the lower channel at about 25 cfm and at a temperature of about 120 to 125° F. (about 49-52° C.). Water was supplied to the mixing chamber at a flow rate less than about 2 gpm by a 1/15-horsepower pump. Air bubbled into the mixing chamber through about 50 to 60 air supply orifices. In the mixing chamber, air and water mixed. The mixture was then injected into the tub through orifices in the tub bottom. The air-water mixture was injected at a very uniform temperature, and no evaporative cooling effect was felt in the tub. The massaging action was very pleasant.

A test was devised to illustrate the improvement in temperature control with the inventive air-water injection system over prior art air-only injection systems. The time for the tub water to drop 4° C. in temperature was recorded for various circulation and injection systems. For a conventional air-only injection system, using heated air, the tub water temperature dropped 4° C. in about 20 minutes. For an inventive tub according to the third example above but without water heating, the tub water temperature dropped 4° C. in about 60 minutes. Thus, the inventive air-water injection system, utilizing an air-water mixing chamber and a plurality of orifices, results in a bathtub retaining heat about three times longer than a conventional air-injected bathtub. The reason for the rapid loss of temperature in the prior art tub is believed to be the evaporative cooling effect of relatively dry air passing through the tub water. The inventive system is believed to effectively humidify the air before injection into the tub by mixing air and water in a mixing chamber with sufficient residence time to approach thermal and vapor-liquid equilibrium. Thus, a high volume of moist air can be injected without any evaporative cooling effect on the bath water temperature or on an occupant's skin. The volume percent air in the air-water mixture is not particularly limited, but may be greater than 50%, or in the range from 70% to 99%, or in the range from about 90% to about 99%. Thus, the invention enables a relatively high air flow compared to conventional water venturi jet systems. Thus, the gentle massaging action of air-injection tubs is provided without the dominating effect of conventional water jets.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A bathtub comprising:
at least one mixing chamber;
a water pump and heater for heating and circulating water from said bathtub to said at least one mixing chamber;
an air blower and heater for delivering heated ambient air to said mixing chamber; and
a plurality of orifices in fluid communication with said mixing chamber for delivering an air-water mixture from said mixing chamber into said bathtub.

2. The bathtub of claim 1 wherein a wall of said bathtub is associated with a wall of said mixing chamber; and wherein said orifices are located in said associated wall providing direct fluid communication between said mixing chamber and said bathtub.

3. The bathtub of claim 1 wherein said orifices are connected to at least one manifold, and said manifold is connected to said mixing chamber providing indirect fluid communication between said mixing chamber and said bathtub.

4. The bathtub of claim 1 wherein said circulating water is pumped into said mixing chamber through at least two spaced water inlet openings.

5. The bathtub of claim 1 wherein said air is pumped into said mixing chamber through a plurality of air supply orifices.

6. The bathtub of claim 1 wherein said air-water mixture comprises at least about 50% air by volume.

7. The bathtub of claim 1 wherein said air-water mixture comprises from about 70% to about 99% air by volume.

8. The bathtub of claim 1 wherein said orifices are arranged in a hole pattern and said mixing chamber is in the form of a half-pipe arranged to cover said hole pattern.

9. The bathtub of claim 1 wherein said air-water mixture has a residence time in said mixing chamber of at least about one-third second.

10. A bathtub with an air-water injection system comprising: an external mixing chamber with at least one air supply inlet and at least one water supply inlet, a plurality of orifices through one or more bathtub walls, and fluid communication means between said mixing chamber and said orifices for conducting an air-water mixture from said mixing chamber into said bathtub.

11. The bathtub of claim 10 further comprising: a pressurized, heated water supply connected to said water inlet; and a pressurized, heated air supply connected to said air inlet; wherein said supplies, inlets, mixing chamber and orifices are sized to provide a residence time for said air-water mixture in said mixing chamber of at least one-half a second and an air volume percent in said air-water mixture of from about 70% to about 99%.

12. The bathtub of claim 10 wherein said mixing chamber is in the form of a half pipe covering said orifices; and wherein said mixing chamber air inlet further comprises a plurality of air inlet orifices in said half pipe.

13. A method comprising:
providing a pressurized, heated water supply to a mixing chamber having at least one water inlet and at least one air inlet;
providing a pressurized, heated air supply to said at least one air inlet of said mixing chamber;
mixing said air and said water in said mixing chamber for the longer of at least one-third second and sufficient time for said mixture to approach thermal and vapor-liquid equilibrium;
injecting said air-water mixture into a bathtub of water through a plurality of orifices provided in a tub wall below the water surface.

14. The method of claim 13 further comprising:
controlling said air and water supplies to provide a volume percent of air in said air-water mixture of from about 50% to about 99%.

15. The method of claim 14 wherein said bathtub and said mixing chamber have a common wall, and a plurality of said orifices are in said common wall.

16. The method of claim 15 wherein said air inlet comprises a plurality of air supply orifices.
